(19) United States
(12) Patent Application Publication
(10) Pub. No.: US 2006/0150508 A1
(43) Pub. Date: Jul. 13, 2006

(54) Nursery pot stabilization system

(76) Inventors: Carl E. Whitcomb, Stillwater, OK (US); Andrew C. Whitcomb, Stillwater, OK (US)

Correspondence Address: STREETS & STEELE, 13831 NORTHWEST FREEWAY, SUITE 355, HOUSTON, TX, 77040, US

(21) Appl. No.: 11/016,169

(22) Filed: Dec. 17, 2004

(51) Int. Cl. A01G 9/02

(52) U.S. Cl. 47/86

(57) ABSTRACT

A plant container system that has sufficient stability to remain upright under strong winds. The system comprises a rigid spacer that defines a perimeter, a plurality of plant containers disposed about the perimeter of the rigid spacer, and a plurality of fasteners for firmly securing the rigid spacer to the rim region of each container, wherein each container has a rim region and is stabilized by the other containers; Accordingly, the spacer secures, couples or links a plurality of containers together in a configuration that stabilized all of the containers. The system is well adapted for use in pot-in-pot production of plants.

### BACKGROUND OF THE INVENTION

1. Field of the Invention

The present invention relates to the stabilization of plant containers against wind forces.

2. Background of the Related Art

The production of plants in a container involves many considerations. Beyond simply providing soil, water and sunlight, the efficient nursery production of plants involves optimizing plant growth and health using cost-effective means. Plant nurseries also desire to maintain a wide selection of plant types, varieties, and sizes in order to meet customer needs.

In order to meet these complex and competing production considerations, a nursery operator desires methods and equipment that provide both operational flexibility and efficiency. Accordingly, nursery facilities typically include large outdoor operations where plants are grown in containers to facilitate management of soil, water and sunlight conditions, as well as to facilitate handling of the plant within the nursery and for delivery to market. The containers are commonly set directly on soil or aggregate surfaces, since other complex or permanent structures are not cost-effective. Greenhouses and other protective structures are even more costly, thereby limiting their use. Accordingly, many nursery operations involve production of plants outdoors.

Outdoor nursery facilities must cope with wide variations in weather conditions, including wide changes in ambient temperatures, unpredictable precipitation, and occasional damaging winds. These weather conditions complicate the task of providing each plant with an environment that fosters its growth. For example, plants need water, soil and nutrients, support or stabilization, and sunlight. In addition, plants may benefit from occasional pruning, weeding, fertilizing, and ridding the plant of pests. Each of these considerations must be taken into account in any nursery processes or facilities layout.

Plants with significant height or foliage may be easily blown over with only modest winds due in part to a considerable amount of leverage that can be exerted on the container. For any given wind speed or direction, plants with more height and more foliage are more likely to be blown over. Containerized trees that are several feet tall are particularly subject to being blown over and suffering damage to the limbs or disturbing the root system. An overturned tree can also damage adjacent plants.

Trees and other plants in nature have a network of roots that naturally anchor the plant in soil. However, when the roots and soil are in a container, the plant is no more stable than the container. Typical nursery plant containers or pots have a round base and a sidewall that is either cylindrical or frustoconical. The base is often narrow and the sides are often made of a flexible plastic material. These containers are made frustoconical so they will nest for shipping from the manufacturer to the nursery.

Nursery plant production must also consider the spacing of plants so as to meet the sunlight requirements of particular species and sizes of plants. Whereas a bigger container can, in general, support a bigger plant, it is not effective to rely upon the diameter of the container to establish the spacing of the containers and, therefore, the spacing of the plants. In other words, the spacing of adjacent plants should be considered independently of the size of the container. Furthermore, containers that provide the benefits of air-root-pruning must expose the side walls to air.

Therefore, the stabilization of nursery pots is not a simple matter. The proper spacing must be maintained, the roots must not be disturbed or damaged, and access to the plants must not be overly restricted. A few attempts to stabilize nursery containers are discussed below.

Whitcomb (U.S. Pat. No. 4,793,097) discloses a plant frame that holds multiple containers from blowing over and also protects the container growth medium and root system from temperature extremes. While the frame is effective, the frame can only accommodate containers of a predetermined size and spacing. Furthermore, the frame itself can catch wind and could increase the chances of blowing over.

Loosen (U.S. Pat. No. 5,836,105) discloses a basal stabilizer apparatus to keep containers from blowing over. The apparatus includes a circular base having a central cavity defined by upwardly extending vertical projections attached to the base. There are openings between the vertical projections for placement of stakes for securing the device above the ground. However, the apparatus attempts to stabilize the container by a base with a smaller diameter than the container and providing for staking of the base to the ground. However, the base cavity will only accommodate containers of a given size and shape, the staking of the base reduces operational flexibility, and the vertical sidewalls require that the container be lifted vertically for removal. These considerations limit the practical benefit of the apparatus.

Most recently, Van Reed et al. (U.S. Pat. No. 6,419,195) discloses an array of stabilizing devices, each device having a base and a central upright, hollow, frusto-conical structure with a retention arm adjustably positioned within the top thereof. The object to be retained, such as a plant container, is positioned on portions of the bases of the devices, and the retention arm of each device is positioned over a portion of the object. These devices are cumbersome, time-consuming, and do not accommodate multiple containers as in a nursery setting. Furthermore, the stabilization provided by the devices is believed to be ineffective with a plant having appreciable height.

Therefore, there is a need for an apparatus or system that prevents containerized plants from blowing over in an outdoors nursery production operation. It is desirable that the container stabilization apparatus or system should avoid catching wind. It is also desirable that the apparatus or system should be capable of efficient storage for reuse without disassembly. Preferably, the apparatus or system would not require staking and can accommodate multiple containers. Even more preferably, the apparatus or system would provide operational flexibility and achieve proper plant spacing, physical access, and mobility. Still, the apparatus or system should accommodate the use of lightweight plastic containers of any of a variety of common designs.

### SUMMARY OF THE INVENTION

The invention provides a plant container system, comprising a rigid spacer defining a perimeter; three or more plant containers disposed about the perimeter of the rigid spacer, each plant container having a rim region; and a plurality of fasteners for firmly securing the rigid spacer to the rim region of each plant container, wherein each plant container is stabilized. Preferably, the plurality of plant containers consists of from 3 to 6 plant containers, most preferably from 3 to 4 plant containers. In certain embodiments, the rigid spacer has a curvilinear shape selected from a circle, square, triangle, polygons, irregular and combinations thereof. Regardless of the shape, the rigid spacer may optionally form a ring, solid sheet, grid, or a combination thereof. In some embodiments, the rigid spacer comprises a bent metal bar, a plurality of metal bars coupled together, or a combination thereof. Further still, the rigid spacer may optionally comprise spokes. In one preferred embodiment, the spacer is essentially planar.

In one embodiment, the containers have at least one hole for receiving a fastener. For example, the plant container might be an air-root-pruning container including a protuberance that provides the at least one hole. It should be recognized that the fasteners may be separate devices, integral to the containers, or integral to the spacer. It is especially beneficial, when the fastener is a separate device, for the spacer to be marked to identify equal spacing around the perimeter.

In accordance with the invention, the plant containers may have any side wall type, including sidewalls selected from smooth, air-root-pruning, root-tip-trapping, and combinations thereof. Furthermore, the plant containers may comprise, without limitation, a rigid pot, a flexible sidewall panel, or a fabric bag. Preferably, the system of containers secured by a spacer is adapted for storage in a nested configuration with another identical system.

The system of the invention may further comprise a second spacer firmly secured to one of the containers and have one or more additional containers firmly secured to the second spacer.

The invention also provides a plant container system, comprising a rigid spacer defining a perimeter; a plurality of container support structures disposed about the perimeter of the rigid spacer and having a rim region firmly secured to the rigid spacer, wherein each container support structure is stabilized by the other support structures; and a plurality of production containers, each production container removably received within one of the container support structures. Optionally, the production containers can be selected from smooth-walled containers, air-root-pruning containers, root-tip-trapping containers, and combinations thereof. Furthermore, the support structure is preferably a support container.

One embodiment of the invention also includes a plant container system, comprising three or more plant containers having a rim region; a first rigid spacer having a first perimeter; and a second rigid spacer having a second perimeter different than the first perimeter, wherein the first and second rigid spacers are interchangeably fastened to the rim regions of the plant containers to provide different spacing of the plant containers. Optionally, each of the plant containers may be a support container adapted to removably receive a production container.

Another embodiment provides a method of stabilizing plant containers, comprising obtaining a rigid spacer having a perimeter that is suitable to position plant containers at a spacing that is appropriate for the plants to be grown in the plant containers; disposing three or more of the plant containers about the perimeter of the rigid spacer; and firmly attaching the rigid spacer to a rim region of each of the three or more plant containers. The method may further comprise setting the containers on an outdoor surface without staking. One method includes detaching one of the plant containers from the rigid spacer.

### BRIEF DESCRIPTION OF THE DRAWINGS

FIGS. 1A, 1B and 1C are perspective, plan and side views, respectively, of an exemplary plant container system of the present invention.

FIGS. 2A and 2B are schematic side view of two plant container systems illustrating how the containers are stabilized when included in the system.

FIG. 3 shows various schematic plan views of plant container systems illustrating some of the possible configurations of the system.

FIG. 4 is a cross-sectional side view of a container secured to a spacer by a fastener in accordance with a first embodiment.

FIG. 5 is a cross-sectional side view of a container secured to a spacer by a fastener in accordance with a second embodiment.

FIG. 6 is a cross-sectional side view of an air-root-pruning container secured to a spacer by a fastener in accordance with a third embodiment.

FIG. 7 is a cross-sectional side view of an air-root-pruning container secured to a spacer by a fastener in accordance with a fourth embodiment.

FIGS. 8A and 8B are cross-sectional and elevational side views, respectively, of a container secured to a spacer by a fastener in accordance with a fifth embodiment.

FIGS. 8C and 8D are cross-sectional and elevational side views, respectively, of a container wall secured to a spacer by a clip-on type fastener in accordance with a sixth embodiment.

FIG. 8E is a cross-sectional side views of a container wall secured to a spacer by a clip-on type fastener in accordance with a seventh embodiment.

FIG. 9 is a cross-sectional side view of a container secured to a spacer by a fastener in accordance with an eighth embodiment.

FIG. 10 shows cross-sectional views of a few exemplary spacers.

FIG. 11 is a plan view of an exemplary plant container system of the present invention.

FIG. 12 is a cross-sectional side view of a pot-in-pot configuration having support containers secured by a spacer and a production container received in each support container.

FIG. 13 is a schematic side view illustrating that the stabilized container assemblies can be stored in a nested configuration.

### DETAILED DESCRIPTION OF PREFERRED EMBODIMENTS

The present invention provides a plant container system that has sufficient stability to remain upright under strong winds. The system comprises a rigid spacer that defines a perimeter, a plurality of plant containers disposed about the perimeter of the rigid spacer, and a plurality of fasteners for firmly securing the rigid spacer to the rim region of each container, wherein each container has a rim region and is stabilized by the other containers. Accordingly, the spacer secures, couples or links a plurality of containers together in a configuration that stabilized all of the containers.

The spacer is secured to the plurality of containers and distributes forces caused by wind among the containers. The spacer secures the containers together in such a manner that leverages the weight of the containers and their contents to stabilize all of the containers. Essentially, the forces applied against one container are opposed by the other containers. By taking full advantage of leverage, the stability of the containers is significantly improved. Preferably, the containers are equally spaced about the perimeter of the space, but the invention is not limited to equal spacing.

The rigid spacer may have any suitable shape, such as a curvilinear shape selected from a circle, square, triangle, polygon, spokes, irregular and combinations thereof. Regardless of the exact shape, the rigid spacer defines a perimeter that can be easily secured to a plurality of containers. The term “perimeter,” as used herein, means the outer boundary of an object. The perimeter of the spacer may be circumferential, curvilinear, triangular, rectangular, or polygonal. Furthermore, the spacer may enable containers to be secured at any set of points along the perimeter, such as with a circular ring spacer, or only at defined points along the perimeter, such as with a spacer made with spokes. The spacer may be fitted with loops, holes, hooks or other attachment mechanisms to aid in securing it to the rim region of the containers and preventing movement of the container around the spacer.

The rigid spacer preferably has a minimal profile so that the spacer itself does not catch much wind. For example, spokes or a ring with an open central region is generally preferred over a solid plate.

The rigidity of the spacer enables forces to be distributed among the containers. Most common structural materials will have sufficient rigidity to serve this function. For example, the rigid spacer may be made from metal, plastics, wood, composites, or combinations thereof. A metal spacer may be preferred because of its high rigidity, water resistance and durability under a variety of physical and environmental conditions. A plastic spacer may be made that is lighter and more customized for a specific container than a simple metal spacer, but the plastic is preferably treated for stability to ultraviolet light. Suitably, the plastic may be the same as the material used to make the containers. Such materials are well known to those with skill in the art.

In operation, the spacer is secured to a rim region of a plurality of containers disposed about the perimeter of the spacer. The “rim region” is the upper portion of the container sidewall, including the very top and the lip, if any. Reference to a rim region does not imply any specific container wall construction or the presence of a lip. However, the spacer is most usefully secured to the upper most portion of the rim region along the top edge of the container, because the edge is the easiest part of the region to access and a high attachment of the spacer provides the greatest amount of stabilization. If the spacer is being secured to a container already filled with growth medium, the only practical position to secure the spacer is at the uppermost edge of the rim region.

The rigid spacer may be secured to the container in any of a variety of ways. First, it is possible to form the rigid spacer as part of an integral assembly with the containers. Alternatively, the spacer and containers may be secured together with fasteners. Any fastener having suitable strength may be utilized. Specifically, the fastener may be a separate component or a feature of either the spacer or the container. However, preferred embodiments require only minor changes, such as the drilling of a hole, or no change to the container itself.

The fasteners may include, without limitation, plastic cable ties, twisted wire, U-bolts, Velcro straps, elastic bands, screws, clips, rivets or pop-rivets, plastic clamps, or spring steel clamps. The choice of fastener will depend upon the configuration of the spacer. It is also possible for the spacer to be either molded integrally with the containers or affixed with adhesives.

The fasteners may establish a fixed connection or a pivotal connection. For example, a clamp or three-point connection may produce a relatively fixed connection. When the spacer is fastened to the container such that the spacer is not allowed to pivot relative to the container, then the stability is even greater. However, it should be recognized that the rigid spacer and the container walls are not likely to be perfectly stiff and that a certain amount of twisting, bending and somewhat independent movement may occur. On the other hand, a single strap, tie or band would probably allow some degree of pivoting between the spacer and the container. However, a connection that can pivot is not particularly detrimental to the stabilization of the containers, since the connections to other containers constrain the amount of pivoting that the connection will experience.

In one embodiment, the fastening of the spacer to the containers is facilitated by providing at least one hole in each container for receiving a fastener. Such a hole may be provided specifically for the purpose of fastening a spacer to the container or the hole may be a preexisting hole or feature of the container, such as a protuberance of an air-root-pruning container. An exemplary air-root-pruning container is disclosed in U.S. Pat. No. 4,939,865, which patent is incorporated by reference herein.

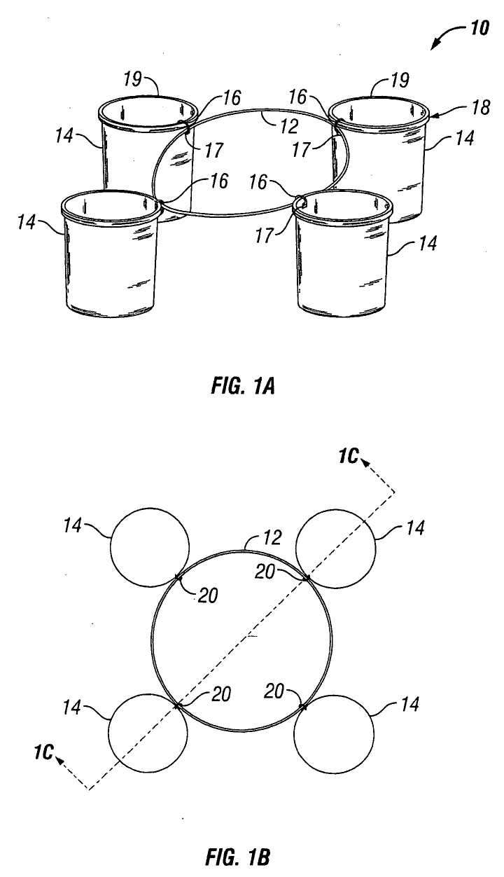

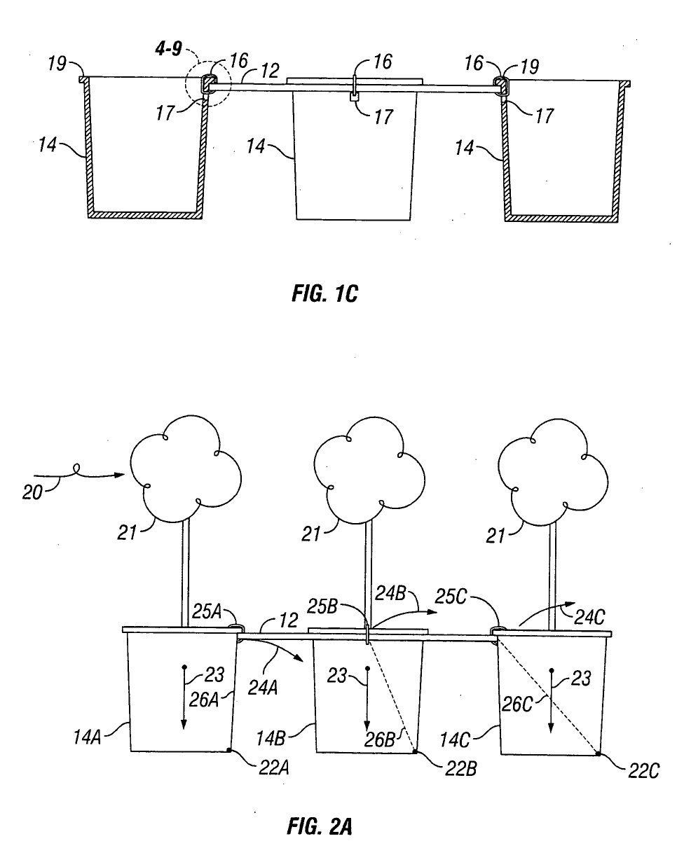

FIG. 1A is a perspective views of an exemplary plant container system 10 of the present invention. The system 10 is shown including a rigid, circular ring spacer 12 and four containers 14 disposed around the perimeter of the spacer 12. The spacer 12 is positioned to contact each container along a rim region 18 near the top of the container 14. The rim region 18 is the upper ⅓ to ¼ of the container height. The spacer 12 is secured to the container 14 within the rim region by a fastener 16, such as a cable tie, by passing the cable tie through a hole 17 in the wall of the container 14. Preferably, the spacer is secured immediately adjacent a lip or rim 19 of the container. When the containers already include holes in the rim region 18, it may be preferred to secure the spacer adjacent those holes whether or not the holes are immediately adjacent the lip or rim.

FIG. 1B is a plan view of the container system 10 showing four containers 14 secured at four attachment points 20 along the perimeter of the spacer 12. The spacer 12 may be made with any suitable size of perimeter, diameter or other dimension in order to create more or less space between the containers. Typically, the container spacing is dictated or influenced by the growth habit and/or light requirements of tops of the particular species of plant being grown in the containers. For example, maple trees that are particularly tolerant of shade may be grown in the three gallon containers with a central spacer of eight to 10 inches. On the other hand, oak tree seedlings or pines or other conifers that are much less tolerant of shade and grown in three gallon containers may need a central spacer of 12 to 16 inches. Further still, a plant with a broad and bushy growth habit will typically need more space.

FIG. 1C is a cross-sectional side view of the container system 10 as viewed along the section indicated in FIG. 1B. The fastener 16 is shown passing through hole 17, over the lip 19 of each container 14, and around the rigid circular ring spacer 12 before being secured to itself in the form a loop. Preferably, the fastener will secure the spacer firmly against the container wall.

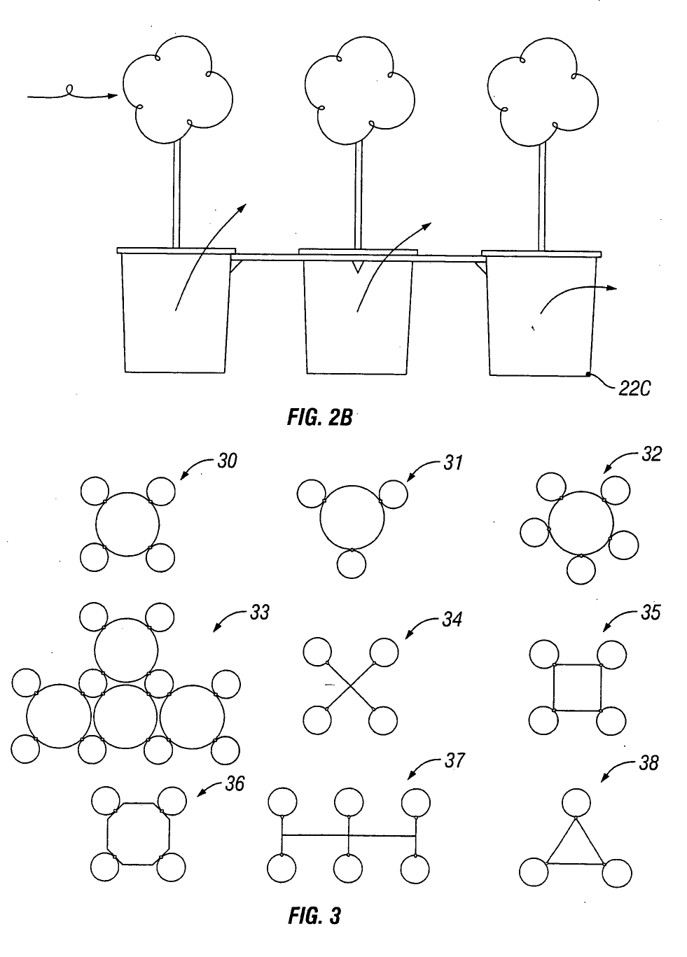

FIG. 2A is a schematic side view of the plant container system 10 illustrating how the containers are stabilized when included in the system. The spacer 12 is pivotally secured in the rim region of the containers 14 to provide an effective load transfer between containers. The system provides the greatest degree of stability against blow over when the central spacer is secured to the container at the highest possible point. To illustrate this point, assume that wind applies a force against the top of trees 21 growing in the containers. The bottom of the containers 14 experience friction with the underlying ground or pavement such that the bottom resists sliding. Accordingly, the force 20 is effectively a rotational force acting about a point 22 on the downwind side of the container bottom. The rotational force 20 is opposed by a counter-rotational force 23 caused by the weight of the container, growth medium and tree therein. Without having the spacer 12, the container 14A will blow over whenever the force 20 sufficient exceeds the force 23 in order to produce the net rotational force 24.

However, in accordance with the invention, the spacer 12 is positioned to oppose the net force 24 from container 14A and is secured to the other containers 14B, 14C (and in accordance with FIG. 1B, a fourth container not shown). Therefore, the rotational force 20 of the wind against all the trees must exceed the counter-rotational forces 23 of the containers and their contents before any of the container can begin to tip over. The degree of stabilization provided by the invention can be largely attributed to the rigidity of the spacer 12 and the geometry of the resulting system. Regardless of the exact wind direction with respect to the system, the system will always have at least one container that is located generally downwind from at least one other container in the system. Furthermore, the containers are secured to the spacer at points of attachment that vary from container to container. For example, in FIG. 2A the up-wind container 14A (on the left) is secured to the spacer 12 at point 25A on the down-wind side (it's right side), the middle container 14B is secured to the spacer 12 at a point 25B which is in the middle of the container diameter, and the down-wind container 14C (on the right) is secured to the spacer 12 at point 25C on the upwind side (it's left side). Because the spacer is rigid (generally inelastic) and the points of attachment do not slide appreciably, the distance between any two attachment points must remain relatively constant. However, each attachment point has a different lever arm about a pivot point 22. Therefore, as all the containers begin to tip over together (say to the right in FIG. 2A), each attachment point will travel a different distance. Specifically, point 25A will immediate move right and downward (along an arc 24A defined by the pivot 22A and lever arm 26A), point 25B will immediate move right and slightly upward (along an arc 24B defined by the pivot 22B and the slightly longer lever arm 26B), and point 25C will immediate move right and even more upward (along an arc 24C defined by the pivot 22C and the even longer lever arm 26C). Since the spacer is rigid, the attachment points cannot move further apart and tipping of the containers is constrained. This tipping action can only continue if the wind forces are great enough to drag the pivot points 22A, 22B, 22C closer together. This requires overcoming frictional forces between the containers and their support material, which may include soil and gravel. Accordingly, the invention provides a surprising additional degree of stability.

As an example supporting further discussion, assume that four containers are connected by a rigid spacer at the top of the container as shown in FIGS. 1A-2B. As wind blows the tops of plants, the wind load is transferred to all four containers. If the wind blows onto the group of four containers such that the wind load strikes more or less a triangular pattern (directed at an apex of the square configuration), in order for the down-wind container to blow over, it must lift a substantial portion of the weight of the two adjacent containers. Additionally, the more the inside portion of the down-wind container is raised, additional pressure down is transferred to the up-wind container as the two ‘side’ containers serve as pivot points.

Similarly, if the wind blows more or less against the square side of the group of four containers, as the two containers on the down-wind side begin to tilt and lift upward on the inside, the up-wind side of the central spacer is pushed downward and additional pressure is placed on the inner sides of the two up-wind containers.

FIG. 2A is a schematic side view of the plant container system 10 illustrating how the containers are stabilized when included in the system with fasteners that are not allowed to pivot. The stability of this embodiment is even greater in that the entirety of the system must tilt as a single unit about the pivot point 22C. Even so, fasteners that would provide an attachment this solid are probably impractical. Further still, the containers themselves have a degree of flexibility that might prevent the system from acting as a single unit under such extreme forces.

FIG. 3 shows various schematic plan views of plant container systems illustrating the system of the invention in a few of the possible configurations. In each illustration, the containers have been shaded. One system 30 includes four containers secured to the circular ring spacer; system 31 includes three containers secured to a circular ring spacer; system 32 includes five containers secured to a circular ring spacer; system 33 includes an array of ten containers secured by three spacers; system 34 includes four containers secured by a spoke-type spacer; system 35 includes four containers secured to the apexes of a square spacer; system 36 includes four containers secured to the sides of an octagonal spacer; system 37 includes six containers secured to the branches of a spacer; and system 38 includes three containers secured to the apexes of a triangular spacer. In a manner similar to system 33, it should be recognized that any of these or other systems of the invention may be coupled together with any spacer to form a complex array. The relative size of the containers and spacers may be customized to meet the specific needs of nursery plant production.

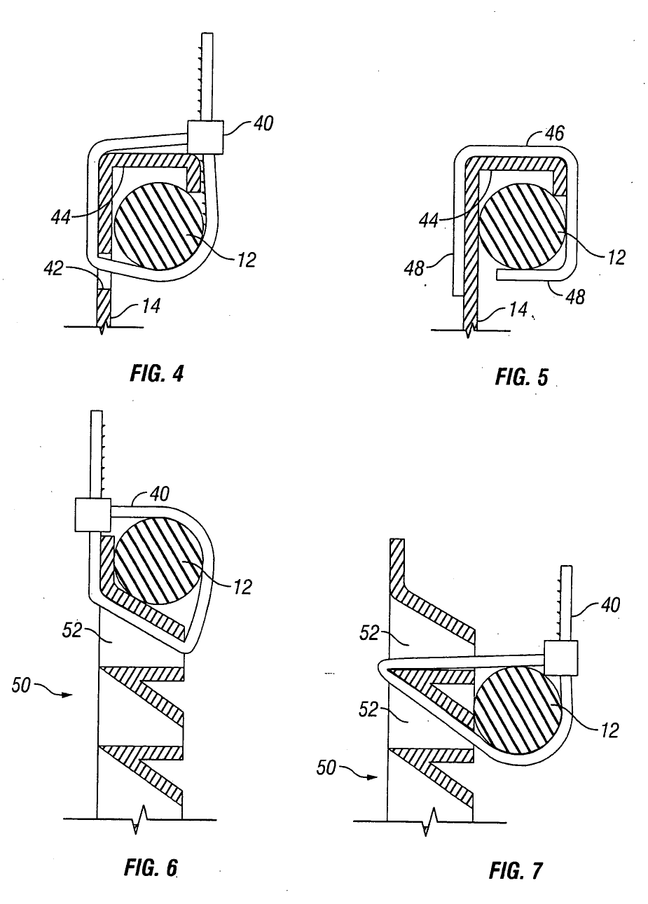

FIG. 4 is a cross-sectional side view of a container wall 14 secured to a spacer 12 by a conventional plastic cable tie-type fastener 40. Here, a hole 42 is provided in the rim region of the container wall 14 for passage of a portion of the cable tie 40. The cable tie 40 is secured back to itself and drawn tight so that the spacer 12 is securely held against the container wall 14. If the container has an outwardly extending rim 44, then it is preferred to provide the hole 42 at an appropriate distance from the rim 44 in order to draw the spacer up securely against the rim. In this manner, the connection between the spacer 12 the container 14 is very stable.

FIG. 5 is a cross-sectional side view of a container wall 14 secured to a spacer 12 by a spring clip-type fastener 46. Installation of the spring clip 46 requires only the temporary prying open of the clip legs 48 so that it can be fitted around the wall 14, rim 44 and spacer section 12 before letting it snap back into the shape shown.

FIG. 6 is a cross-sectional side view of a container section having an air-root-pruning sidewall 50 secured to a spacer 12 by a cable tie-type fastener 40. The cable tie may pass through a hollow protuberance 52 already formed in the sidewall 50 and pulled tight to firmly secure the spacer to the wall.

FIG. 7 is a cross-sectional side view the air-root-pruning sidewall 50 of FIG. 6 having the spacer 12 secured between two adjacent protuberances 52.

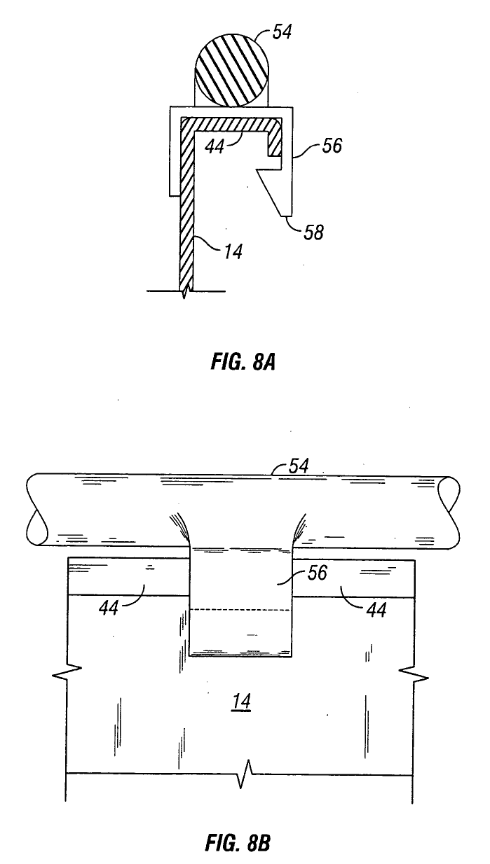

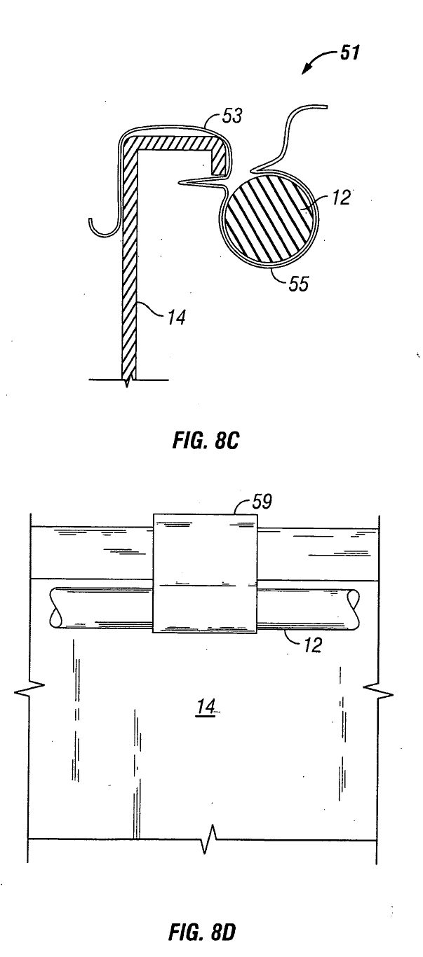

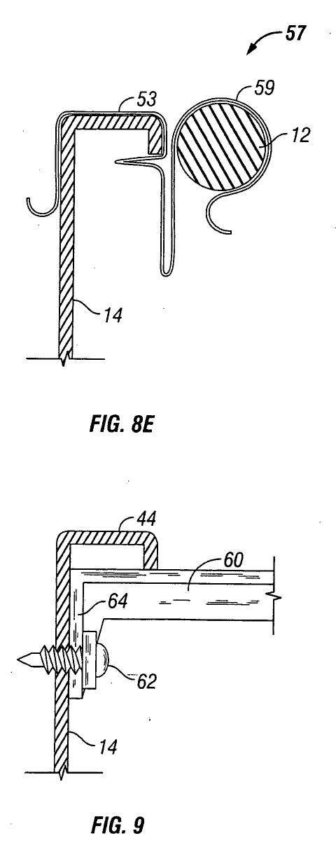

FIGS. 8A and 8B are cross-sectional and elevational side views, respectively, of a container wall 14 secured to a spacer 54 having clip-type fastener 56. The fastener 56 is attached to the spacer 54 either by a separate fastener, welding or adhering, or forming in a single piece. Alternatively, the fastener 56 may simply loop over the top of the spacer 54. Regardless, the clip-type fastener 56 is pressed down over the rim 44 of the wall 14 so that the leg 58 flexes outwardly, then snaps back into the position shown. Some configuration of the spacer 54 then extends to another container (not shown) for securing thereto.

FIGS. 8C and 8D are cross-sectional and elevational side views, respectively, of a container wall 14 secured to a spacer 12 by a clip-on type fastener or clip 59, such as made from spring steel or plastic. Whereas the clip 56 of FIG. 8A is shown with a single receptacle, the clip 51 has two receptacles, a first receptacle 53 for receiving and securing the rim 44 of the container wall 14 and a second receptacle 55 for receiving and securing the spacer 12. Each receptacle of the clip can be flexed outwardly to open up and receive the rim or spacer, then snap back into the position shown. FIG. 8E is a cross-sectional view of another clip-on type fastener or clip 57 having two receptacles 53, 59 which operate in much the same fashion as the receptacles of clip 51. Various other clip styles and design will be apparent to one of ordinary skill in the art and are intended to be included within the scope of the invention.

FIG. 9 is a cross-sectional side view of a container wall 14 secured to a molded plastic spoke-type spacer 60 by a hand screw-type fastener 62 that extends through a spacer flange 64 and the wall 14. The spacer 60 is shown being a “T-beam” or an “L-beam” that extends directly toward the sidewall 14 as would a spoke-type spacer, branched spacer, or various other spacers. However, even a circular ring spacer may include a flange in order to be secured in a similar manner.

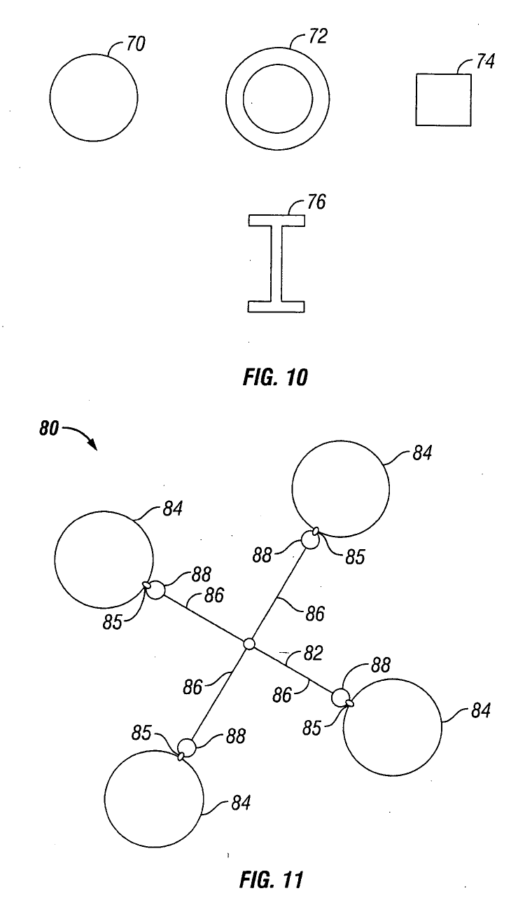

FIG. 10 shows cross-sectional views of a few exemplary spacer sections, without limitation. The selection of a spacer cross-section is independent of the spacer shape. For example, a spacer may have a solid circular cross-section 70, tubular cross-section 72, solid square cross-section 74, or an “I-beam” cross-section 76. Any of these or other apparent cross-sections may be formed into one of the spacer shapes previous disclosed, such as a circular ring, octagonal ring, or spokes. A circular ring spacer made from a tubular material may provide improved rigidity without excessive weight, whereas a circular ring spacer made from a solid bar may have better durability and lower cost.

FIG. 11 is a plan view of an exemplary plant container system 80 of the present invention. The spacer 82 has spokes that extend to four containers 84. In order to utilize certain fasteners 85, such as the fasteners of FIGS. 4-7, the end of each spoke 86 is provided with a hook or loop 88 that functions as the cross-section 12 of FIGS. 4-7. Alternatively, the hook or loop could be downwardly depending so that a screw, bolt, rivet or pop-rivet, or similar fasteners could extend directly through the hook or loop and into the wall of the container.

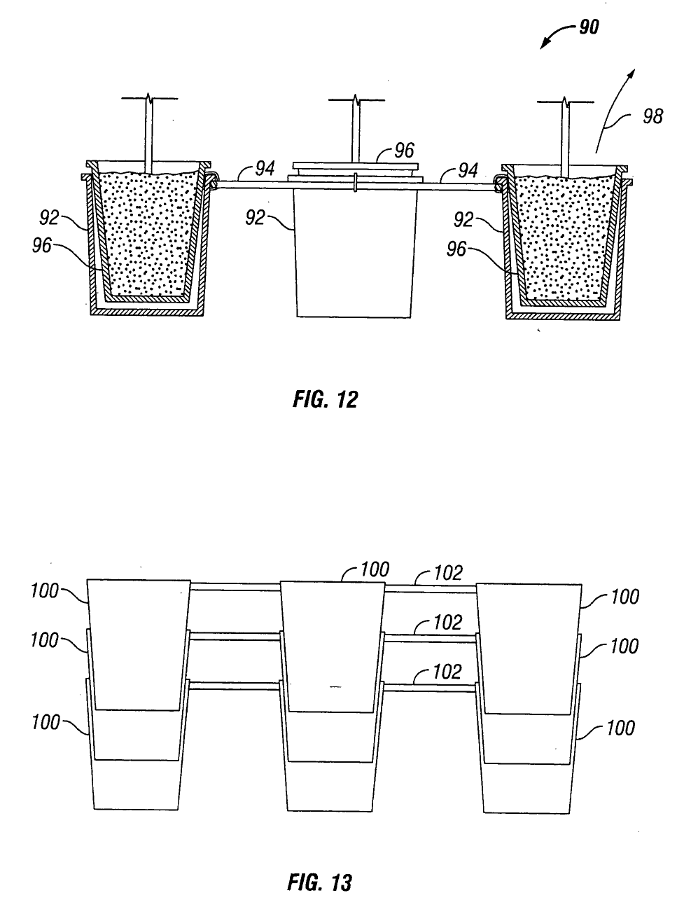

FIG. 12 is a cross-sectional side view of a pot-in-pot system 90 having support containers 92 secured by a spacer 94. Each of the support containers are suitable to removably receive and secure a production container 96. A preferred system includes four containers of an appropriate size to function as support pots for four production containers. In all other respects, the system functions the same as the previous embodiments that directly couple production containers. One advantage of the pot-in-pot system 90 is that the integrated support containers 92 and spacer 94 can be used over and over without detaching, while the production containers 96 are inserted then easily removed by lifting in an upward direction 98 when the plant is sold.

FIG. 13 is a schematic side view illustrating that the stabilized systems of the invention, such as the systems 10, 30-38, 80, 90 previous discussed, can be stored in a nested configuration. This is true whether the containers 100 are production containers 14 or support containers 92. Since the spacer 102 is secured to the rim region of each container, the spacer does not prevent efficient nested stacking of the assembled systems. It is anticipated that systems having four containers, for example, can be stacked for winter with the containers nested one inside the other. The systems can then be un-stacked and used again the next growing season.

The terms “plant container” and “plant pot” are used interchangeably herein and are deemed to be synonymous. However, as used herein, the terms “plant container” and “plant pot” should be taken in a broad sense to include a variety of plant container and plant pot types used in plant production, including containers known as air-root-pruning containers and root-tip-trapping containers, both of which may comprise a sidewall panel with or without a base member. A plant container retains a growth medium, such as soil, that is suitable to support root growth.

The terms “comprising,” “including,” and “having,” as used in the claims and specification herein, shall be considered as indicating an open group that may include other elements not specified. The term “consisting essentially of,” as used in the claims and specification herein, shall be considered as indicating a partially open group that may include other elements not specified, so long as those other elements do not materially alter the basic and novel characteristics of the claimed invention. The terms “a,” “an,” and the singular forms of words shall be taken to include the plural form of the same words, such that the terms mean that one or more of something is provided. For example, the phrase “a solution comprising a phosphorus-containing compound” should be read to describe a solution having one or more phosphorus-containing compound. The term “one” or “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (not required) feature of the invention.

It should be understood from the foregoing description that various modifications and changes may be made in the preferred embodiments of the present invention without departing from its true spirit. The foregoing description is provided for purposes of illustration only and should not be construed in a limiting sense. Only the language of the following claims should limit the scope of this invention.

1. A plant container system, comprising:
a rigid spacer defining a perimeter;
a plurality of plant containers set on a surface and spaced about the perimeter of the rigid spacer, each container having a rim region; and
a plurality of fasteners for firmly securing the rigid spacer to the rim region of each container, wherein each container is stabilized.

2. The system of claim 1, wherein the plurality of plant containers is from 3 to 6 containers.

3. The system of claim 2, wherein the rigid spacer is a curvilinear shape selected from a circle, square, triangle, polygons, irregular and combinations thereof.

4. The system of claim 3, wherein the rigid spacer forms a ring, solid sheet, grid, or a combination thereof.

5. The system of claim 3, wherein the rigid spacer comprises a bent metal bar, a plurality of metal bars coupled together, or a combination thereof.

6. The system of claim 2, wherein the rigid spacer comprises spokes.

7. The system of claim 2, wherein each container has at least one hole for receiving a fastener.

8. The system of claim 7, wherein the plant container is an air-root-pruning container including a protuberance that provides the at least one hole.

9. The system of claim 2, further comprising a second spacer firmly secured to one of the plurality of containers and one or more additional containers firmly secured to the second spacer.

10. The system of claim 3, wherein the spacer is essentially planar.

11. The system of claim 2, wherein each of the plant containers has a side wall type selected from smooth, air-root-pruning, root-tip-trapping, and combinations thereof.

12. The system of claim 2, wherein each of the plant containers is selected from a rigid pot, a flexible sidewall panel, and a fabric bag.

13. The system of claim 3, wherein the fasteners are separate devices, integral to the containers, or integral to the spacer.

14. The system of claim 2, wherein the system is adapted for storage in a nested configuration with another identical system.

15. The system of claim 3, wherein the spacer is marked to identify equal spacing around the perimeter.

16. A plant container system, comprising:
a rigid spacer defining a perimeter;
a plurality of container support structures set on a surface and spaced about the perimeter of the rigid spacer and having a rim region firmly secured to the rigid spacer, wherein each container support structure is stabilized by the other support structures; and
a plurality of production containers, each production container removably received within one of the container support structures.

17. The system of claim 16, wherein the plurality of container support structures is from 3 to 6 containers.

18. The system of claim 17, wherein the rigid spacer has a shape selected from a circle, square, triangle, polygons, irregular, spoked and combinations thereof.

19. The system of claim 18, wherein the rigid spacer has a central region that is open.

20. The system of claim 17, wherein the rigid spacer forms a ring, solid sheet, grid, or a combination thereof.

21. The system of claim 17, wherein the rigid spacer is made from a material selected from metal and plastic.

22. The system of claim 17, wherein the rigid spacer comprises one or more metal bars.

23. The system of claim 17, further comprising:
a fastener for securing each support structure to the spacer.

24. The system of claim 17, wherein the rigid spacer is integral to the support structures.

25. The system of claim 17, further comprising a second spacer firmly coupling one of the support structures to one or more additional support structures.

26. The system of claim 18, wherein the spacer is essentially planar.

27. The system of claim 17, wherein the production containers are selected from smooth-walled containers, air-root-pruning containers, root-tip-trapping containers, and combinations thereof.

28. The system of claim 17, wherein the support structure is a support container.

29. A plant container system, comprising:
three or more plant containers having a rim region;
a first rigid spacer having a first perimeter;
a second rigid spacer having a second perimeter different than the first perimeter, wherein the first and second rigid spacers are interchangeably fastened to the rim regions of the plant containers to provide different spacing of the plant containers.

30. The system of claim 29, wherein each of the plant containers is a support container adapted to removably receive a production container.

31. A method of stabilizing plant containers, comprising:
obtaining a rigid spacer having a perimeter that is suitable to position plant containers at a spacing that is appropriate for the plants to be grown in the plant containers;
disposing three or more of the plant containers about the perimeter of the rigid spacer; and
firmly attaching the rigid spacer to a rim region of each of the three or more plant containers, wherein each container is.

32. The method of claim 31, further comprising:
setting the containers on an outdoor surface without staking.

33. The method of claim 31, further comprising:
detaching one of the plant containers from the rigid spacer.

34. A plant container system, consisting essentially of:
a rigid spacer defining a perimeter;
a plurality of plant containers set on a surface and spaced about the perimeter of the rigid spacer, each container having a rim region; and
a plurality of fasteners for firmly securing the rigid spacer to the rim region of each container, wherein each container is stabilized.

35. The system of claim 34, wherein the containers are set on an outdoor surface.

36. The system of claim 34, wherein the rigid spacer has a central region that is open.

37. The system of claim 34, wherein the plurality of plant containers is from 3 to 6 containers.

38. The system of clan 34, wherein the rigid spacer is a curvilinear shape selected from a circle, square, triangle, polygons, irregular and combinations thereof.

39. The system of claim 34, wherein the rigid spacer forms a ring.

40. The system of claim 34, wherein the rigid spacer comprises a bent metal bar.

41. The system of claim 34, wherein the rigid spacer comprises spokes.

42. The system of claim 34, wherein the rigid spacer is essentially planar.

43. The system of claim 34, wherein each of the plant containers has a side wall type selected from smooth, air-root-pruning, root-tip-trapping, and combinations thereof.

44. The system of claim 34, wherein each of the plant containers has a flexible sidewall panel.

45. The system of claim 34, wherein the fasteners are separate devices.

46. The system of claim 34, wherein the system is adapted for storage in a nested configuration with another identical system.

47. The system of claim 34, wherein the spacer is marked to identify equal spacing around the perimeter.
